(19) United States
(12) Patent Application Publication
(10) Pub. No.: US 2015/0103477 A1
(43) Pub. Date: Apr. 16, 2015

(54) Building-Block Display Device

(71) Applicant: Top Victory Investments Ltd., Kowloon (HK)

(72) Inventors: Yung-Chi Teng, New Taipei City (TW); Ming-Huang Lee, New Taipei City (TW); Nick Lu, New Taipei City (TW)

(73) Assignee: Top Victory Investments Ltd., Kowloon (HK)

(21) Appl. No.: 14/053,717

(22) Filed: Oct. 15, 2013

(51) Int. Cl. G06F 1/16

(52) U.S. Cl. CPC G06F 1/1601
USPC 361/679.21

(57) ABSTRACT

The present invention provides a building-block display device. The building-block display device includes a display module, a supporter, a casing and a plurality of engaging units. The casing is disposed on the display module in a surrounding manner. The plurality of engaging units is respectively disposed on outer surfaces of the supporter and the casing. The supporter is detachably connected to the casing via the engaging units. Comparing to the prior art, the present invention has advantages of appearance malleability and adjustable convenience of the display device.

### BACKGROUND OF THE INVENTION

1. Field of the Invention

The present invention relates to a display device, and more particularly, to a building-block display device.

2. Description of the Prior Art

Outer surfaces of the casing and the supporter of the conventional display device have flat structures, connection between the supporter and the casing is achieved by specific fixing mechanism, which results in expensive cost. The conventional supporter including a height adjustable mechanism has drawbacks of complicated structure and expensive material cost. Appearance of the conventional display device is invariable after the product is designed and manufactured. The appearance of the display device can not be varied according to consumer's demand.

### SUMMARY OF THE INVENTION

The present invention provides a building-block display device, the display device includes elements capable of being assembled and disassembled as the building blocks, so as to increase appearance malleability and adjustable convenience of the display device.

According to the claimed invention, the building-block display device includes a display module, a supporter, a casing and a plurality of engaging units. The casing is disposed on the display module in a surrounding manner. The plurality of engaging units is respectively disposed on outer surfaces of the supporter and the casing. The supporter is detachably connected to the casing via the engaging units.

According to an embodiment of the claimed invention, the engaging unit comprises a protruding structure.

According to the embodiment of the claimed invention, the protruding structure is a column substantially.

According to the embodiment of the claimed invention, the engaging unit further comprises a sunken structure, and a shape of the sunken structure is matched with a shape of the protruding structure.

According to the embodiment of the claimed invention, the supporter further comprises a body and a base. An end of the body is connected to the casing, the other end of the body is connected to the base, and the body is detachably connected to the base via the engaging units.

According to another embodiment of the claimed invention, the supporter further comprises a body, an adjustable block and a base. An end of the body is connected to the casing, the other end of the body is connected to the adjustable block, and an end of the adjustable block opposite to the body is connected to the base. The body, the adjustable block and the base are detachably connected to each other via the engaging units.

According to the embodiment of the claimed invention, the building-block display device further includes an exterior component detachably connected to the outer surfaces of the supporter or the casing via the engaging units.

According to the embodiment of the claimed invention, the engaging units are respectively disposed on the outer surfaces of the supporter and the casing as an array.

The display device of the present invention includes the elements capable of being assembled and disassembled as the building blocks, so as to increase appearance malleability and adjustable convenience of the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a building-block display device according to a preferred embodiment of the present invention.

FIG. 2 and FIG. 3 are diagrams of the building-block display device in different views according to a preferred embodiment of the present invention.

FIG. 4 is an exploded diagram of a building-block display device according to the other embodiment of the present invention.

FIG. 5 is a diagram of the building-block display device according to the other embodiment of the present invention.

FIG. 6 is an exploded diagram of a building-block display device according to another embodiment of the present invention.

FIG. 7 is a diagram of the building-block display device according to another embodiment of the present invention.

### DETAILED DESCRIPTION

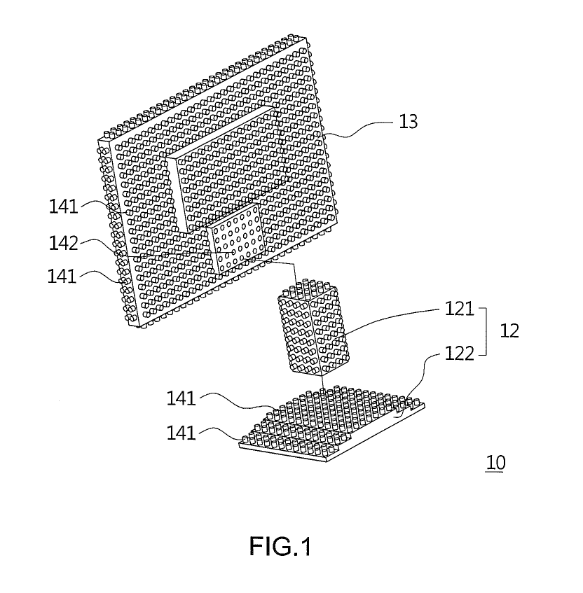

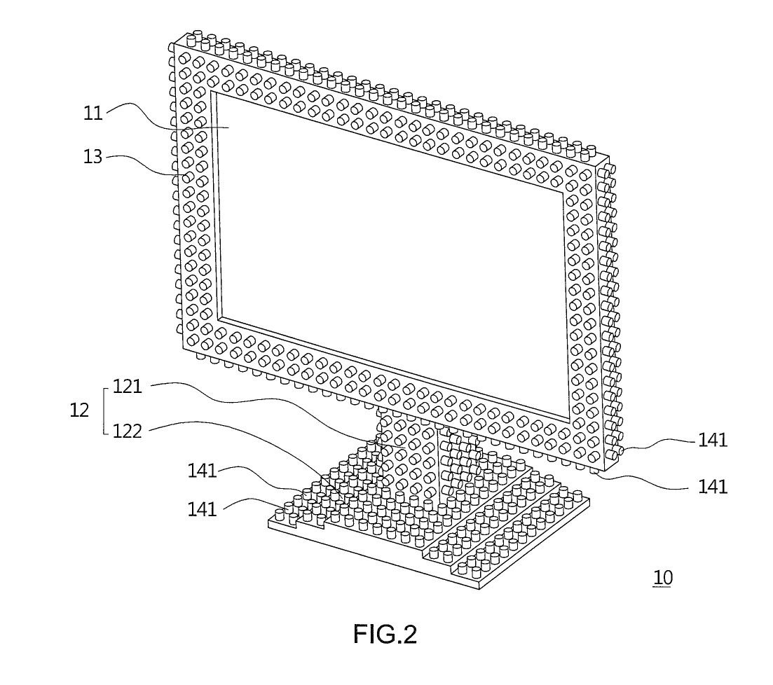

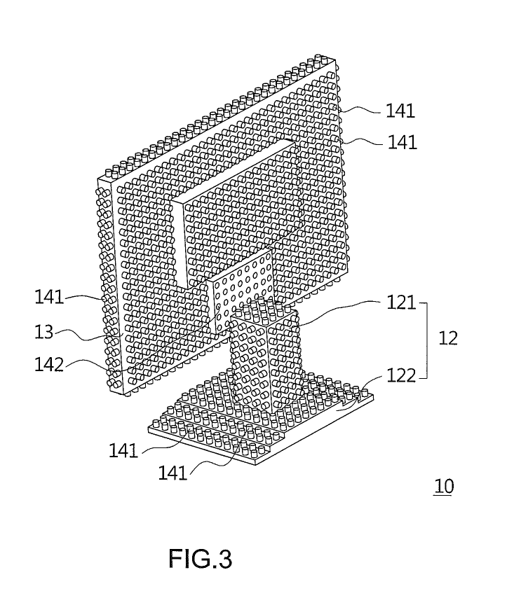

Please refer to FIG. 1 to FIG. 3, which illustrate a building-block display device 10 according to an embodiment of the present invention. The building-block display device 10 includes a display module 11, a supporter 12, a casing 13 and a plurality of engaging units. In this embodiment, the display module 11 includes, but not limited to, a liquid crystal panel, a backlight unit and a driving circuit. The casing 13 is disposed around the display module 11 in a surrounding manner. The plurality of engaging units is respectively disposed on outer surfaces of the supporter 12 and the casing 13. The supporter 12 and the casing 13 are detachably connected to each other via the engaging units.

The engaging unit includes a protruding structure 141 and a sunken structure 142. A shape of the protruding structure 141 is matched with a shape of the sunken structure 142. The protruding structure 141 can be a column substantially, and the sunken structure 142 is an annular slot accordingly. The protruding structure 141 can be engaged with the sunken structure 142 in a tight fit manner for detachable connection. In this embodiment, the engaging units are uniformly disposed on the outer surfaces of the casing 13 and the supporter 12 as an array.

The supporter 12 includes a body 121 and a base 122. The protruding structure 141 is disposed on an upper edge of the body 121, the sunken structure 142 is disposed on a bottom of the body 121 (not shown in figures), and the protruding structure 141 is further disposed on the base 122. Thus, the bottom of the body 121 can be detachably connected to the base 122. In addition, the sunken structure 142 is disposed on a low edge of a back of the casing 13, which means the engaging unit disposed on a specific area of the back's low edge of the casing 13 is the sunken structure 142. For assembly of the supporter 12 and the casing 13, the upper edge of the body 121 of the supporter 12 aligns with the specific area on the back of the casing 13, and then the body 121 is pressed toward the casing 13 to engage the protruding structure 141 with the sunken structure 142 accordingly. Furthermore, the body 121 is inversely forced to separate from the casing 13 for disassembly of the supporter 12 and the casing 13. The assembly and the disassembly of the display device 10 of the present invention resemble application of the building blocks.

In the other embodiment, the sunken structure further can be disposed on the other specific area on the casing, such as a left edge or a right edge of the back of the casing. The supporter can be selectively engaged with the left edge or the right edge of the back of the casing, so as to stand the casing as an upright form. Further, a height of the casing can be adjusted by movement of a position where the upper edge of the supporter connects to the back of the casing.

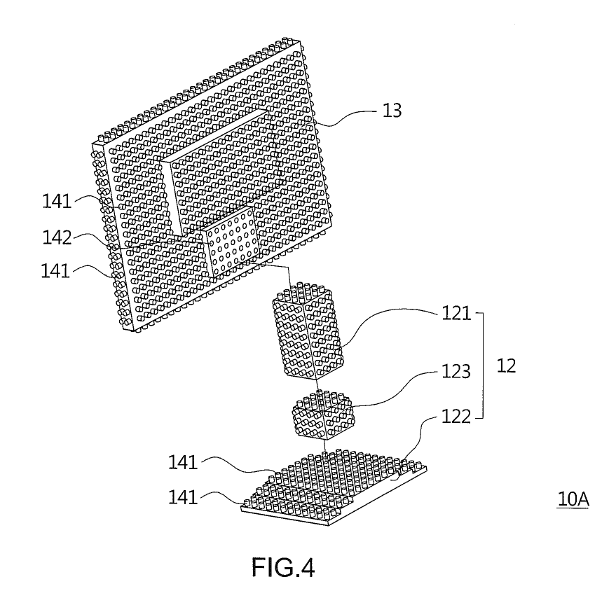

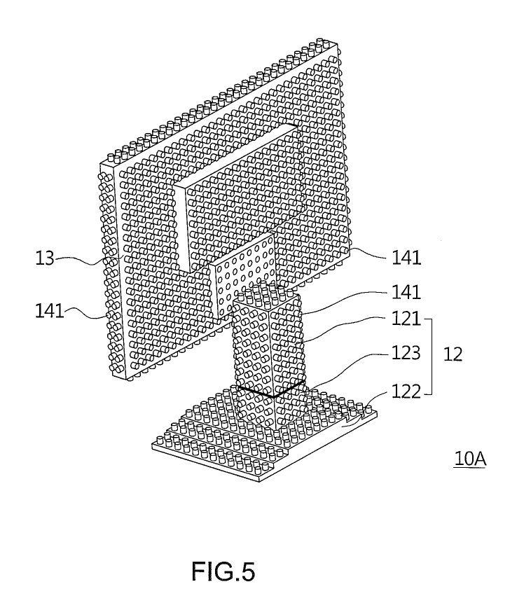

Please refer to FIG. 4 and FIG. 5, which illustrate a building-block display device 10A according to the other embodiment of the present invention. Difference between the building-block display device 10 and the building-block display device 10A is that the supporter 12 of the building-block display device 10A includes the body 121, the base 122 and an adjustable block 123. The end of the body 121 is connected to the casing 13 via the engaging units, the other end of the body 121 is connected to the adjustable block 123, and an end of the adjustable block 123 opposite to the body 121 is connected to the base 122. The adjustable block 123 can be utilized to adjust the height. The body 121, the base 122 and the adjustable block 123 are detachably connected to each other via the engaging units. It is to say, the plurality of sunken structure 142 (not shown in figures) is disposed on the bottom of the body 121, the plurality of protruding structures 141 is disposed on the top of the adjustable block 123, the plurality of sunken structure 142 (not shown in figures) is further disposed on the bottom of the adjustable block 123. Therefore, the top of the adjustable block 123 can be detachably engaged with the bottom of the body 121, the bottom of the adjustable block 123 can be detachably engaged with the base 122, and the height of the supporter 12 can be increased according to a structural height of the adjustable block 123.

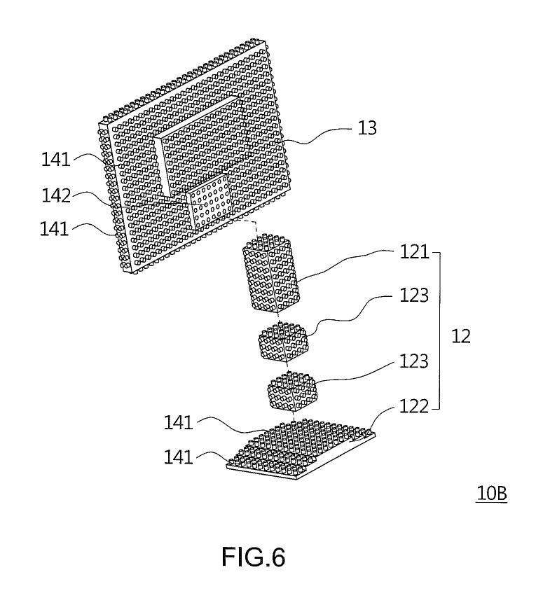

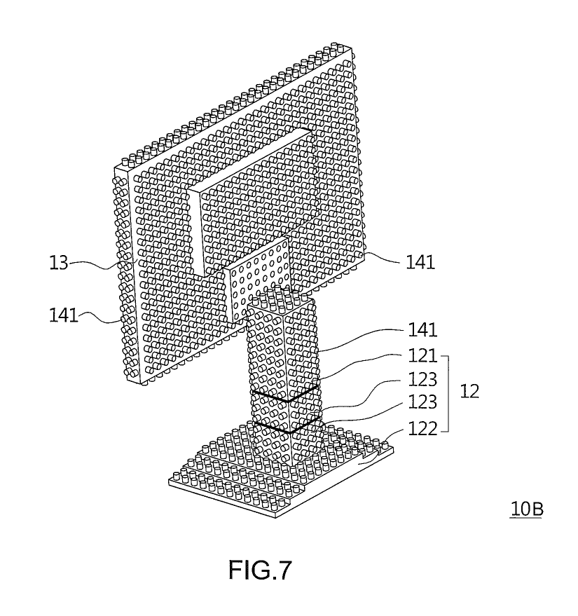

Please refer to FIG. 6 and FIG. 7, which illustrate a building-block display device 10B according to another embodiment of the present invention. The building-block display device 10B can include a plurality of adjustable blocks 123, for example, an amount of the adjustable block 123 can be two. The first adjustable block 123 is engaged with the bottom of the body 121, the second adjustable block 123 is engaged with the bottom of the first adjustable block 123, and the bottom of the second adjustable block 123 is engaged with the base 122. The height of the supporter 12 can be increased according to the total height of the stacked adjustable blocks 123. Thus, the height of the casing 13 can be adjusted by the amount of the adjustable block 123 for convenient increase and decrease.

On the other embodiment, the building-block display device further can include an exterior component disposed on the casing or the supporter. The exterior component can be the building block with pattern or character. The sunken structure is disposed on a side of the exterior component to detachably engage with the protruding structure disposed on the outer surface of the casing or the supporter accordingly, so as to vary appearance of the building-block display device. Besides, the exterior component can be the structure with a holder. A mobile phone can be put on the holder when the exterior component is assembled with the base.

In conclusion, the display device of the present invention includes the elements capable of being assembled and disassembled as the building blocks, so as to increase appearance malleability and adjustable convenience of the display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A building-block display device comprising:
a display module;
a supporter;
a casing disposed on the display module in a surrounding manner;
a plurality of engaging units disposed on outer surfaces of the supporter and the casing, the supporter being detachably connected to the casing via the engaging units.

2. The building-block display device of claim 1, wherein the engaging unit comprises a protruding structure.

3. The building-block display device of claim 2, wherein the protruding structure is a column substantially.

4. The building-block display device of claim 2, wherein the engaging unit further comprises a sunken structure, a shape of the sunken structure is matched with a shape of the protruding structure.

5. The building-block display device of claim 1, wherein the supporter further comprises a body and a base, an end of the body is connected to the casing, the other end of the body is connected to the base, and the body is detachably connected to the base via the engaging units.

6. The building-block display device of claim 1, wherein the supporter further comprises a body, an adjustable block and a base, an end of the body is connected to the casing, the other end of the body is connected to the adjustable block, an end of the adjustable block opposite to the body is connected to the base, the body, the adjustable block and the base are detachably connected to each other via the engaging units.

7. The building-block display device of claim 1, further comprising:
an exterior component detachably connected to the outer surfaces of the supporter or the casing via the engaging units.

8. The building-block display device of claim 1, wherein the engaging units are respectively disposed on the outer surfaces of the supporter and the casing as an array.
